(19) United States
(12) Patent Application Publication
(10) Pub. No.: US 2016/0290160 A1
(43) Pub. Date: Oct. 6, 2016

(54) TURBOMACHINE WITH A COATING, USE OF A PLASTIC FOR COATING AND METHOD FOR COATING THE TURBOMACHINE

(71) Applicant: SIEMENS AKTIENGESELLSCHAFT, München (DE)

(72) Inventors: Manuel ETTLER, Nörvenich-Wissersheim (DE); Bora KOCDEMIR, Essen (DE); Alexander LITINSKY, Mülheim (DE); Andrey MASHKIN, Köln (DE); Dieter MINNINGER, Dinslaken (DE); Adam ZIMMERMANN, Mülheim a.d. Ruhr (DE)

(73) Assignee: Siemens Aktiengesellschaft, Munich (DE)

(21) Appl. No.: 15/033,292

(22) PCT Filed: Sep. 18, 2014
(86) PCT No.: PCT/EP2014/069875

§ 371 Date: Apr. 29, 2016

(30) Foreign Application Priority Data
Nov. 7, 2013 (EP) 13191892.2

(51) Int. Cl. F01D 25/14; F01D 25/00; F01D 25/24

(52) U.S. Cl. CPC F01D 25/145; F01D 25/24; F01D 25/005; F05D 2220/31; F05D 2230/90; F05D 2300/5023; F05D 2300/432; F05D 2300/44; F05D 2300/20; B05D 1/28

(57) ABSTRACT

A turbomachine includes an inner housing which radially defines the flow channel of the turbomachine. A thermal barrier coating is arranged about the inner housing. The thermal barrier coating of the inner housing is made of microporous plastic coating which can be added to hollow spheres made of different materials and have different sizes. A method for applying a thermal barrier coating to the inner casing of a turbomachine includes preparing a material having a base material which has a microporous plastic; coating the outside of the wall of the inner casing by applying the base material to the inner casing; and curing the applied material, thus forming the thermal barrier coating.

### CROSS REFERENCE TO RELATED APPLICATIONS

This application is the US National Stage of International Application No. PCT/EP2014/069875 filed Sep. 18, 2014, and claims the benefit thereof. The International Application claims the benefit of European Application No. EP13191892 filed Nov. 7, 2013. All of the applications are incorporated by reference herein in their entirety.

### FIELD OF INVENTION

The invention relates to a turbomachine which comprises an inner casing radially bounding the flow duct, wherein a coating is arranged around the inner casing, and also to the use of a plastic for coating and to a method for coating the turbomachine.

### BACKGROUND OF INVENTION

The term turbomachine relates here to a turbine, in particular to a gas turbine, a steam turbine and especially to a low-pressure turbine. In the further context of the description of the invention, the term turbine is to be understood as synonymous with steam turbine or low-pressure turbine.

Steam turbines can be classed, depending on the pressure at which the steam flows into the turbine, as high-, intermediate- or low-pressure turbines, which are also termed turbine sections since they represent sections of an overall turbine installation. In that context, the low-pressure turbines are usually arranged downstream of the high- and intermediate-pressure turbines, corresponding to the steam pressure gradient within a turbine plant. In the process, the temperature of the steam also drops, it being possible for the temperature of the steam to be raised again, by means of what are termed intermediate superheaters, between the turbine sections.

Within a turbine section, the temperature is not homogeneous between the inflow region and the exhaust steam region of the inner casing, since the temperature of the inflowing steam is very high compared to that of the exhaust steam. Furthermore, there is a temperature gradient between the inside and the outside of the wall of the inner casing. This results in stresses within the material, which can lead to casing deformations.

In order to counteract temperature gradients and stresses or deformations caused thereby, the inner casing of steam turbines are usually provided with a sheet metal construction. This sheet metal construction serves for thermal insulation of the inner casing with respect to the outside and for temperature homogenization over the entire inner casing of the turbine. Thermally insulating sheet metal constructions for turbines are currently made of individual sheet metal parts. The metal sheets must be produced according to the construction and matched to the casing. The metal sheets are fitted on cast-on or welded spacers, where they are secured by means of screws so as to produce a cavity between the inner casing and the sheet metal construction. The cavity fills with stagnant steam, thus achieving the insulating effect.

The drawback of sheet metal constructions is that they have to be constructed anew for each series of turbines. It is also necessary, within a series, to adapt sheet metal constructions anew for each structural modification. In this context, there is a further drawback in that mounting the sheet metal constructions is complex and time-consuming. In addition, vibrations and wear can lead to individual metal sheets tearing off from the construction and to screw connections for the metal sheets coming loose, which has a negative effect on stability, thermal insulation and thus on the efficiency of the turbine.

EP 0 374 603 A1 discloses a thermal barrier for hot gas-conducting double-walled components. U.S. Pat. No. 6,641,907 B1 discloses a material system with closely packed hollow shapes with a leaktight wall structure.

### SUMMARY OF INVENTION

Thus, an object is to provide thermal insulation for a turbomachine, wherein the thermal insulation can be produced simply, and to create a method for producing the thermal insulation.

This object is achieved according to the features of the independent claims. Embodiments thereof are indicated in the dependent claims and in the figure.

It has been found that this object is achieved by a turbomachine which comprises an inner casing radially bounding the flow duct of the turbomachine, wherein there is arranged, around the inner casing, a thermal barrier coating which is a coating having a base material that has a microporous plastic. The turbomachine is in particular a turbine, or a steam turbine, or a low-pressure turbine.

The thermal barrier coating can also be termed a thermal protection jacket or cladding; due to the character of the coating, the term thermal barrier coating is preferred.

The inventive thermal barrier coating for the inner casing is advantageous because the coating can be produced simply by application onto the outside of the wall of the inner casing. It is thus not necessary to attach spacers to the inner casing, as for conventional cladding. The inventive thermal barrier coating is also advantageous because it can be applied to any desired shape; this reduces time, complexity, material and thus also costs, which are necessary for protracted fitting and mounting of conventional cladding. The advantageous price-performance ratio means that the invention is also highly efficient.

In one embodiment of the invention, the thermal barrier coating clads the inner casing in annular fashion. In other words, the thermal barrier coating advantageously entirely encloses the inner casing. Coating the entire casing is advantageous since this thermally insulates the inner casing; the homogenization of temperature achieved thereby reduces temperature gradients within the inner casing and reduces the risk of deformations of the inner casing.

An outer casing is advantageously arranged around the inner casing and the thermal barrier coating. The outer casing provides mechanical protection for the internal components and is typically a component of turbomachines. In that context, a further advantage of the inventive thermal barrier coating for the inner casing is that the thermal load on the material of the outer casing is kept at a low level.

According to the invention, the base material of the coating of the turbomachine has a microporous plastic or a microporous inorganic material such as glass or ceramic. In this case, the base material is also, synonymously, termed the matrix. Microporous denotes porous materials with a pore size less than 2 mm, in particular in the region of a few microns. The use of microporous material is advantageous since this material is characterized by low thermal conductivity and thus good thermal insulation properties, low weight and good mechanical properties. Also, microporous plastics mix well with various fillers. The degree of porosity of the material, that is to say the ratio between total pore volume and external volume of the coating, is between 10% and 90%, advantageously 20% to 70%, more advantageously 25% to 50% and especially advantageously 20% to 40%.

Advantageously, the microporous plastic of the matrix of the coating is selected from the group comprising organic polymers, in particular polyurethane, polyethylene, polyolefin, polyether, polypropylene, polytetrafluoroethylene, epoxy resin, elastomers, zeolites or a mixture thereof, or inorganic materials, in particular ceramic. In that context, polyurethane, polyethylene, polypropylene, epoxy resin, phenol resins such as novolak, and elastomers are more advantageous. Particularly advantageous is the use of polyurethane. It is also advantageous for the plastic to have duroplastic qualities in order to increase the thermal stability of the coating. In that context, the matrix can be provided for coating as resin, foam, casting compound, casting resin, dispersion, solution, 2-component system, moisture-curing prepolymer, but also as granulate or powder.

The matrix of the coating can have fillers which influence the property profile of the coating made of microporous plastic. It is advantageous for the matrix of the coating to have hollow balls as filler. The addition of hollow balls to the matrix is advantageous since thus primarily the thermal barrier properties can be improved, and, by reducing the density of the coating, it is possible to reduce the weight of the coating. Moreover, the hollow ball content counteracts a possible tendency of the matrix to shrinkage, accordingly reduces the tendency of the material of the coating to deformation, and contributes to the stability of the coating. Coatings with hollow balls are thus more lightweight, more insulating, more stable and, because they use less plastic, also more cost-effective.

### BRIEF DESCRIPTION OF THE DRAWINGS

The invention will be described in more detail below with reference to the appended schematic drawing. In the drawing:

FIG. 1 illustrates the makeup of a coating having a microporous plastic in which hollow balls are embedded.

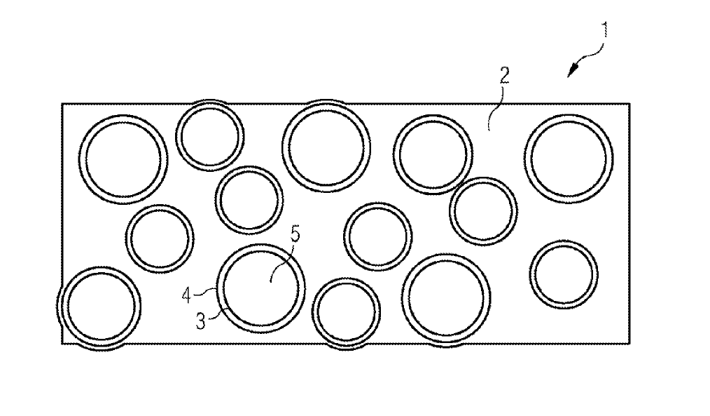

### DETAILED DESCRIPTION OF INVENTION

The material of the hollow balls 3 embedded in the matrix 2 can in that context include organic material, in particular the polymers listed above, or also of polyacrylate, but also of inorganic materials, in particular glass or ceramic.

In that context, an essential factor which influences the thermal barrier effect and weight of the coating 1 is the size of the hollow balls 3. The larger the hollow balls 3, the greater the degree of filling and accordingly the lower the weight of the coating 1 and also the lower the heat-conducting properties. However, the size of the hollow balls 3 should be chosen so as not to jeopardize the mechanical strength of the coating. The size of the hollow balls 3 is defined by their diameter. It is advantageous for the diameter of the hollow balls to be between 5 μm and 1000 μm, more advantageous between 10 μm and 500 μm, even more advantageous between 20 μm and 300 μm and even more advantageous still between 25 μm and 200 μm.

In one embodiment of the invention, all of the hollow balls 3 used as filler can have the same diameter. It is however also possible for different hollow balls 3 to have different diameters, that is to say hollow balls 3 of various sizes are used as filler. The use of various sizes is more advantageous, because smaller balls can fit into spaces between larger balls and thus more space in the coating 1 can be filled with hollow balls 3. In other words, the use of hollow balls 3 of various sizes makes it possible to achieve a greater packing density.

In one embodiment of the invention, coatings 4 can be applied to the outer walls of the hollow balls 3 themselves. In that context, the hollow balls 3 can have organic and/or inorganic coatings 4. Organic coatings 4 can include any suitable polymer compounds, but advantageously of polyurethanes, polyvinyl fluoride or polyester. Inorganic coatings 4 can also have any materials or compounds which are suitable therefor, for example glass, ceramic, silicate, metals, alloys of metals, and salts and oxides of metals or other elements. The coating 4 of the hollow balls 3 is carried out, depending on the type of coating, according to conventional, suitable methods. The coating 4 of the hollow balls 3 is advantageous because it changes the material properties of the balls, for example with respect to the distribution of the hollow balls 3 in the matrix 2, and the mechanical strength and the increase in the thermal barrier effect of the coating 1.

With respect to the total volume of the coating 1, the proportion of hollow balls 3 is advantageously 10% to 90%, more advantageously 20% to 70%, even more advantageously 30% to 60%, and even more advantageously still 35% to 50%.

In one embodiment of the invention, the internal spaces 5 of the hollow balls 3 are filled with gas or liquid. The fillings have an influence on the weight of the hollow balls 3 and thus on the total weight of the coating 1, depending on the type of filling, but also in particular on the thermal barrier properties. In that context, filling with a gas is advantageous since gases are lightweight and less thermally conductive than liquids. In that context, the hollow balls 3 can, in the simplest case, have a simple air filling at approximately standard pressure. It is however also possible for the gas filling to be at increased pressure. Increased pressure is advantageous because it additionally allows the coating to have a vibration-damping effect. Increased pressure is moreover advantageous because it allows the hollow balls 3 to counteract mechanical pressure through the material of the matrix 2. It is however also possible for the gas filling to be at a slight reduced pressure. It is moreover possible for different pressures to prevail in different hollow balls 3, that is to say standard pressure, increased pressure and/or reduced pressure.

For the filling of the internal spaces 5 of the hollow balls 3, it is also possible to use, in addition to air, any other suitable gas, for example nitrogen or carbon dioxide. If liquids are used, any suitable liquid is conceivable in that context.

In one further embodiment, the hollow balls 3 are evacuated, i.e. the hollow balls contain a vacuum or at least a partial vacuum. Evacuated hollow balls are advantageous because heat is not conducted in a vacuum, which makes the thermal insulation effect of the thermal barrier coating more effective. It is further advantageous if evacuated hollow balls are mixed with gas- and/or liquid-filled hollow balls, it being possible for the gas-filled hollow balls to contain gas at various pressures.

The invention further relates to the use of a microporous plastic for coating the inner casing of a turbomachine. In that context, the turbomachine is advantageously a steam turbine, and more advantageously a low-pressure turbine. In one embodiment, use is made, for coating, of a microporous plastic which is mixed with hollow balls as filler. The type of the microporous plastic and of the hollow balls 3 are in that context described above.

The invention further relates to a method for applying a thermal barrier coating to the inner casing of a turbomachine, with the steps of: —preparing a material having a base material which has a microporous plastic;—coating the inner casing by applying the base material to the inner casing;—curing the applied material, thus forming the thermal barrier coating.

The method thus serves for producing the coating 1 of microporous plastic by coating the inner casing with the microporous plastic and then curing. In that context, the microporous plastic is selected from the above-described microporous plastics. Microporous plastics can be provided in the form of a casting compound for an injection molding process, or in the form of a smoothing compound. The use of a smoothing compound is advantageous, because the inner casing of the turbomachine can be coated simply by applying the smoothing compound using a trowel. The microporous material binds to the material of the inner casing and the coating 1 which forms cures during subsequent drying. The material of the outer wall of the casing can in that context be pre-treated according to conventional methods in order to promote adhesion of the coating.

In one embodiment, joins are introduced into the coating 1 prior to curing of the material. The introduction of joins is advantageous since it means that there are, if required, starting points to be able to remove, simply and without damage, and re-join the coating 1.

In another embodiment of the coating method, the microporous plastic has hollow balls 3 as filler. The hollow balls 3 are advantageous for the method because they roll with one another and/or underneath one another, similar to in a ball bearing, and lend the microporous plastic high viscosity and good flow properties. In that context, the material for the hollow balls 3 is selected as described above.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A turbomachine, comprising
an inner casing radially bounding the flow duct of the turbomachine,
a thermal barrier coating arranged around the inner casing which is applied to the outside of the wall of the inner casing and is a coating having a base material that has a microporous plastic.

2. The turbomachine as claimed in claim 1,
wherein the thermal barrier coating clads the inner casing in the circumferential direction in annular fashion.

3. The turbomachine as claimed in claim 1, further comprising:
an outer casing arranged around the inner casing and the thermal barrier coating.

4. The turbomachine as claimed in claim 1,
wherein the microporous plastic is selected from the group comprising polyurethane, polyethylene, polyolefin, polyether, polypropylene, polytetrafluoroethylene, ceramic, epoxy resin, elastomers, zeolites or a mixture thereof, or inorganic materials such as ceramic.

5. The turbomachine as claimed in claim 1,
wherein the base material of the coating has hollow balls as filler.

6. The turbomachine as claimed in claim 5,
wherein the material of the hollow balls is selected from polymers, glass or ceramic.

7. The turbomachine as claimed in claim 5,
wherein the diameter of the hollow balls is between 10 μm and 500 μm.

8. The turbomachine as claimed in claim 5,
wherein different hollow balls have different diameters.

9. The turbomachine as claimed in claim 5,
wherein the hollow balls have organic and/or inorganic coatings.

10. The turbomachine as claimed in claim 5,
wherein the proportion of hollow balls is 35% to 50% by volume with respect to the total volume of the coating.

11. The turbomachine as claimed in claim 5,
wherein the internal space of the hollow balls is filled with gas or liquid.

12. The turbomachine as claimed in claim 5,
wherein the internal space of the hollow balls is evacuated.

13. The turbomachine as claimed in claim 1,
wherein the turbomachine is a low-pressure turbine.

14. A thermal barrier coating applied to the inner casing of a turbomachine, comprising:
a microporous plastic for coating the outside of the wall of the inner casing of the turbomachine.

15. The thermal barrier coating as claimed in claim 14,
wherein the microporous plastic has hollow balls as filler.

16. A method for applying a thermal barrier coating to the inner casing of a turbomachine, of the method comprising:
preparing a material having a base material which has a microporous plastic;
coating the outside of the wall of the inner casing by applying the base material to the inner casing; and
curing the applied material, thus forming the thermal barrier coating.

17. The method as claimed in claim 16,
wherein the microporous plastic has hollow balls as filler.
